(19) United States
(12) Patent Application Publication
(10) Pub. No.: US 2009/0058250 A1
(43) Pub. Date: Mar. 5, 2009

(54) Filter for display apparatus

(75) Inventors: Dong-Keun Sin, ChungCheongNam-Do (KR); Ji-Yoon Seo, ChungCheongNam-Do (KR); Sung-Nim Jo, ChungCheongNam-Do (KR); Ji-Young Kim, ChungCheongNam-Do (KR); Mi-Young Lim, ChungCheongNam-Do (KR); Kyeong-Keun Woo, ChungCheongNam-Do (KR); Dae-Chul Park, ChungCheongNam-Do (KR); Sang-Yoon Oh, ChungCheongNam-Do (KR); Kun-Yong Jang, ChungCheongNam-Do (KR); Hwa-Yeon Lee, ChungCheongNam-Do (KR); Moon-Jin Choi, ChungCheongNam-do (KR); Shin-Wook Kim, ChungCheongNam-Do (KR); Seok-Won Kim, ChungCheongNam-Do (KR); Dong-Hwal Lee, ChungCheongNam-Do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Samsung Corning Precision Glass Co., Ltd., Gyeongsangbuk-do (KR)

(21) Appl. No.: 12/229,930

(22) Filed: Aug. 28, 2008

(30) Foreign Application Priority Data
Aug. 29, 2007 (KR) 10-2007-0087172
Apr. 7, 2008 (KR) 10-2008-0032395
Apr. 7, 2008 (KR) 10-2008-0032396
Apr. 7, 2008 (KR) 10-2008-0032397
Apr. 7, 2008 (KR) 10-2008-0032399
May 8, 2008 (KR) 10-2008-0042926

(51) Int. Cl. H01K 1/26

(52) U.S. Cl. 313/112

(57) ABSTRACT

A filter for a display apparatus is placed in front of a display panel, wherein CIE chromaticity coordinates of the filter under a standard of a D65 light source have values of −2.0≦a*≦2.0 and −2.0≦b*≦2.0. The CIE chromaticity coordinates of the filter under the standard of the D65 light source have a value of 60≦L*≦80. The colorants include a first colorant absorbing 380 nm to 480 nm wavelength light, a second colorant absorbing 450 nm to 550 nm wavelength light, and a third colorant absorbing 560 nm to 620 nm wavelength light. The first to third colorants can be contained in at least one of a color compensating layer, a low-refraction layer having a refractive index of 1.5 or less, an external light shielding layer, a hard coating layer and an adhesive layer.

### CROSS-REFERENCE TO RELATED APPLICATION

This application claims the benefit of Korean Patent Application Nos. 2007-0087172 filed on Aug. 29, 2007, 2008-0032395 filed on Apr. 7, 2008, 2008-0032396 filed on Apr. 7, 2008, 2008-0032397 filed on Apr. 7, 2008, 2008-0032399 filed on Apr. 7, 2008, and 2008-0042926 filed on May 8, 2008, in the Korean Intellectual Property Office, the disclosure of which is incorporated herein by reference.

### BACKGROUND OF THE INVENTION

1. Field of the Invention

The present invention relates to a filter for a display apparatus, and more particularly, to a filter for a display apparatus which provides good exterior and high image quality.

2. Description of the Related Art

As information is getting more important in the modern society, display apparatuses are being remarkably advanced and distributed. The display apparatuses include displays for TVs, monitors of personal computers (PCs) and so on, and their distribution is greatly increasing. Further, the display apparatuses are getting larger sized and thinner at the same time.

In general, a plasma display panel (PDP) is in the limelight as a next generation display apparatus since it can be made larger sized and thinner than a cathode ray tube (CRT), which is representative of existing display apparatuses.

The PDP causes gas discharge between electrodes with a direct or alternating voltage applied to the electrodes, then activates phosphors by ultraviolet radiation subsequent to the gas discharge, and thereby generates light.

However, the PDP has drawbacks such as a large amount of electromagnetic waves and near infrared rays emitted due to driving characteristics thereof and high surface reflectivity of phosphors. Further, the PDP has lower color purity than the CRT due to orange light emitted from gas such as He or Xe. The electromagnetic waves and near infrared rays emitted from the PDP may have a harmful effect to the human body, and cause malfunction of precision appliances such as a cellular phone and a remote controller.

Therefore, the PDP employs a PDP filter in order to shield electromagnetic waves and near infrared rays, reduce light reflection, and improve color purity. The PDP filter is manufactured by gluing or adhering several functional layers such as an electromagnetic shielding layer, a near-infrared shielding layer and a neon peak absorbing layer using bonding or adhesive layers.

However, such a PDP filter of the related art has the following problems.

The PDP filter is assembled to a PDP panel and a cabinet, which form one set. While power is off, the PDP filter acts an important role of representing exterior appearance of the PDP. However, the PDP filter of the related art has been considered and designed only in terms of functions such as electromagnetic shielding, near infrared shielding and neon peak absorbing, and thus its exterior appearance is poor, thereby failing to meet consumers' demands for products.

This is because the filter can not be designed only for visual purposes without considering functional purposes in view of characteristics of the filter through which screen light transmits.

Recently, as consumers recognize electronic appliances such as a TV, a refrigerator and an air conditioner as part of indoor and outdoor interiors, the exterior appearance of the display apparatus is becoming a major factor. Therefore, attempts to improve the exterior appearance of a cabinet have been continued among manufacturers. However, there has been rarely proposed an approach that can improve the exterior appearance of a screen, which is located at the front of an electronic appliance and visually attracts most interest from users.

Furthermore, a PDP filter of the related art is rather a factor that degrades the image quality of the PDP. Particularly, when displaying a dark image such as a black image, the PDP does not properly express black color. Since consumers are getting a keener eye and demanding natural colors, minimizing the loss of images sent from a broadcast station is being more emphasized.

Moreover, in the display apparatus equipped with the filter of the related art, visibility is poor due to low Bright Room Contrast Ratio (BRCR) and the Moire phenomenon may take place.

### SUMMARY OF THE INVENTION

The present invention has been made to solve the foregoing problems with the prior art, and therefore an object of the present invention is to provide a good exterior to a display apparatus.

Another object of the present invention is to prevent an image quality of a display apparatus from degrading. Excellent color reproduction of the display apparatus without degradation in color purity enables the image to be more similar to real colors.

Still another object of the present invention is to improve visibility of a display apparatus by raising bright room contrast ratio (BRCR) and prevent a Moire phenomenon.

Still another object of the present invention is directed to provide a filter for a display apparatus in which the aforementioned objects can be efficiently realized without an additional process, by simply setting optimal chromaticity coordinate values and then determining a colorant blending recipe accordingly.

In an exemplary embodiment the invention, CIE chromaticity coordinates of the filter under a standard of a D65 light source are in ranges: −2.0≦a*≦2.0 and −2.0≦b*≦2.0. The filter is for a display apparatus and will be placed in front of a display panel of the display apparatus. Preferably, the CIE chromaticity coordinates of the filter under the standard of the D65 light source are in a range: 60≦L*≦80. Preferably, the colorants include a first colorant absorbing a 380 nm to 480 nm wavelength light, a second colorant absorbing a 450 nm to 550 nm wavelength light, and a third colorant absorbing a 560 nm to 620 nm wavelength light. Further, the first to third colorants can be contained in at least one of a color compensating layer, a low-refraction layer having a refractive index of 1.5 or less, an external light shielding layer, a hard coating layer and an adhesive layer.

According to the above described constructions, the present invention can provide good exterior to a display apparatus.

In addition, the present invention can prevent an image quality of a display apparatus from degrading. Excellent color reproduction of the display apparatus without degradation in color purity enables the image to be more similar to real colors.

Furthermore, the present invention can improve visibility of a display apparatus by raising BRCR and prevent the Moire phenomenon.

Moreover, in the present invention, the above-described objects can be efficiently realized without an additional process, by simply setting optimum chromaticity coordinate values and then determining a colorant blending recipe accordingly.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 through 8 are schematic cross-sectional views illustrating filters for a display apparatus according to first through eighth embodiments of the present invention;

FIG. 9 is a graph showing relation between filter transmittance and contrast ratio;

FIG. 10 is a graph showing a spectral transmittance curve obtained by measuring the filter for a display apparatus according to the first example of the invention; and

FIGS. 11 and 12 are graphs showing spectral transmittance curves obtained by measuring the filters for a display apparatus according to the first and second comparative examples, which will be compared to the invention.

### DETAILED DESCRIPTION OF THE EXEMPLARY EMBODIMENT

The present invention will now be described more fully hereinafter with reference to the accompanying drawings, in which exemplary embodiments thereof are shown. In the following description of the present invention, a detailed description of known functions and components incorporated herein will be omitted when it may make the subject matter of the present invention rather unclear.

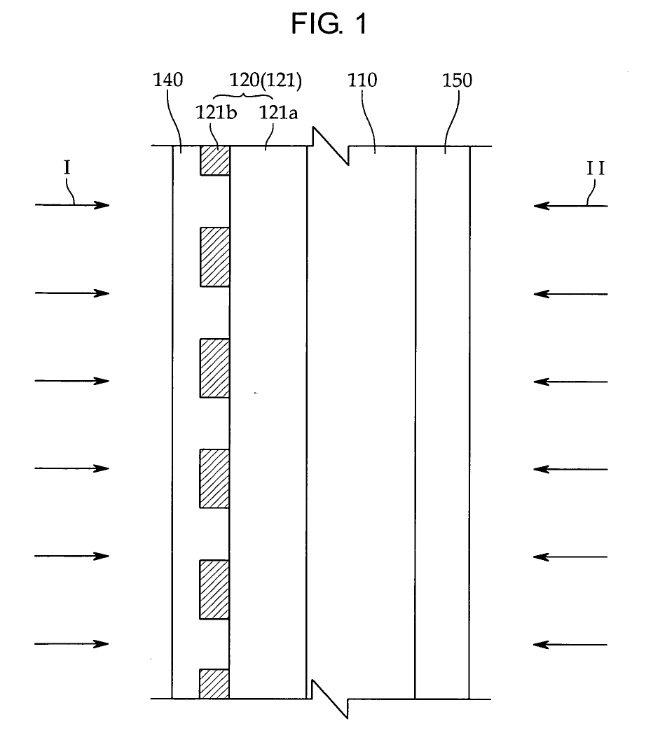

FIGS. 1 through 8 are schematic cross-sectional views illustrating filters for a display apparatus according to first through eighth embodiments of the present invention.

As illustrated in FIGS. 1 through 8, the filters for a display apparatus according to the embodiments have a variety of structures.

The filter typically includes a transparent substrate 110, a color compensating layer 150, and an electromagnetic shielding layer 120. In addition to these components, the filter may further include an external light shielding layer 130, a protective layer 140, an anti-reflection layer 160, a near-infrared shielding layer 170, a diffusion layer (not shown), and so on.

FIG. 1 shows the filter in which the color compensating layer 150, the transparent substrate 110, the electromagnetic shielding layer 120, and the protective layer 140 are stacked in that order from the front at which a viewer is.

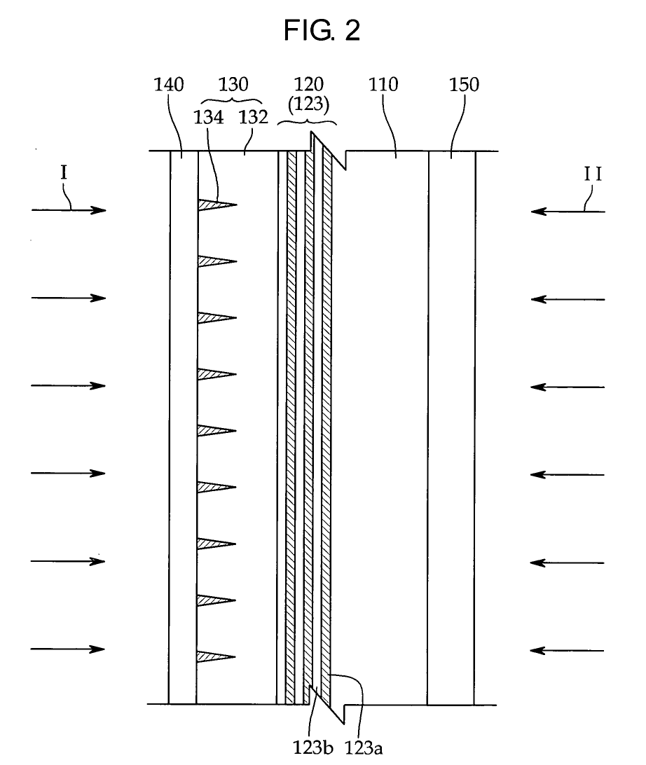

FIG. 2 shows the filter in which the color compensating layer 150, the transparent substrate 110, the electromagnetic shielding layer 120, the external light shielding layer 130, and the protective layer 140 are stacked in that order from the front.

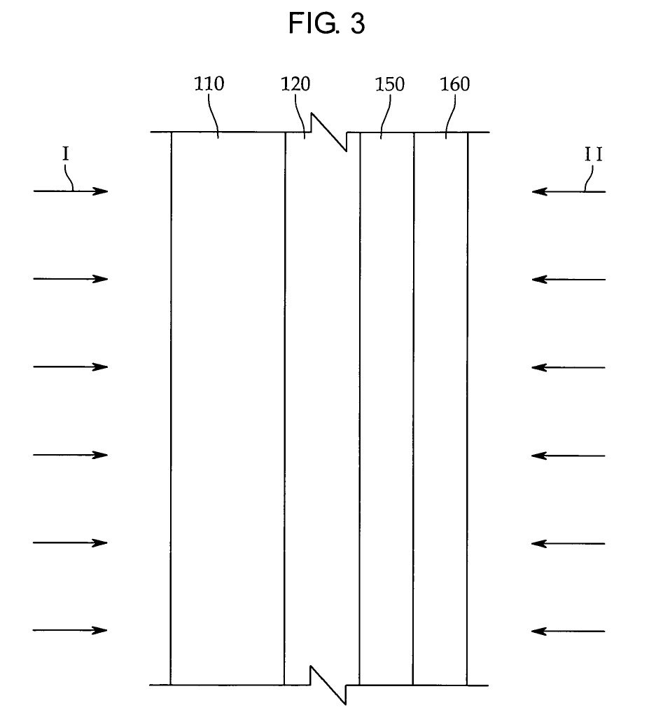

FIG. 3 shows the filter in which the anti-reflection layer 160, the color compensating layer 150, the electromagnetic shielding layer 120, and the transparent substrate 110, are stacked in that order from the front.

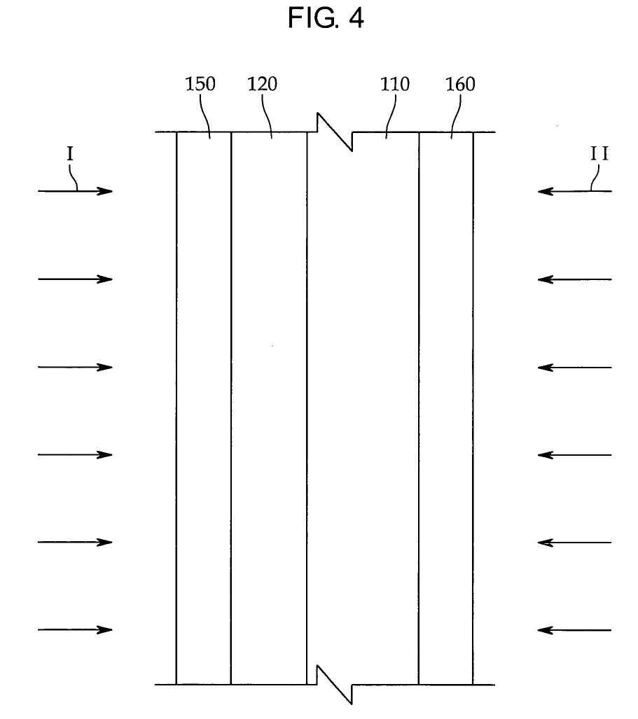

FIG. 4 shows the filter in which the anti-reflection layer 160, the transparent substrate 110, the electromagnetic shielding layer 120, and the color compensating layer 150 are stacked in that order from the front.

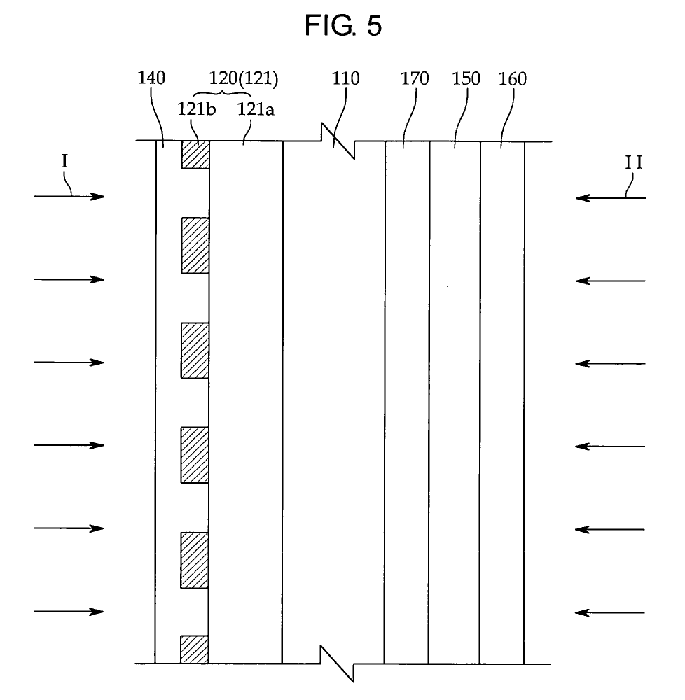

FIG. 5 shows the filter in which the anti-reflection layer 160, the color compensating layer 150, the near-infrared shielding layer 170, the transparent substrate 110, the electromagnetic shielding layer 120, and the protective layer 140 are stacked in that order from the front.

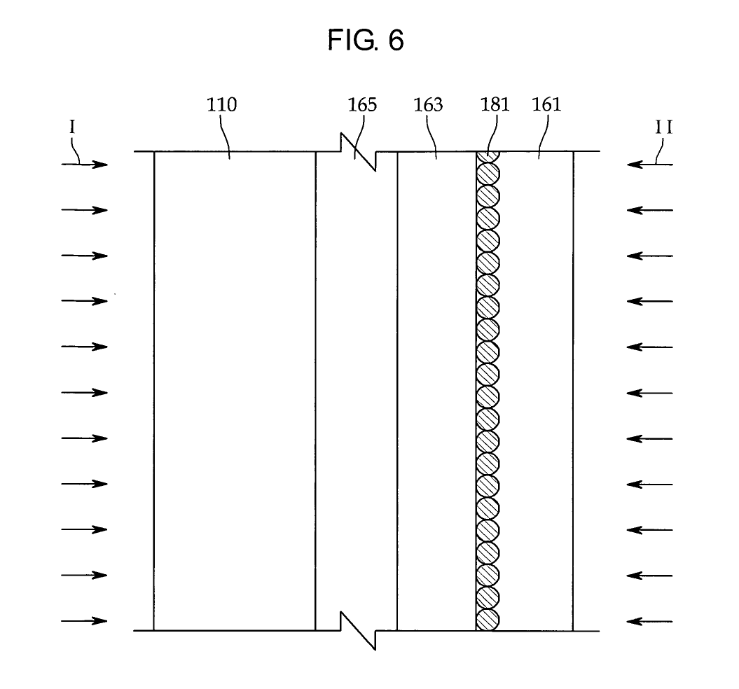

FIG. 6 shows the filter in which a low-refraction layer 161, a high-refraction layer 163, a hard coating layer 165, and the transparent substrate 110 are stacked in that order from the front.

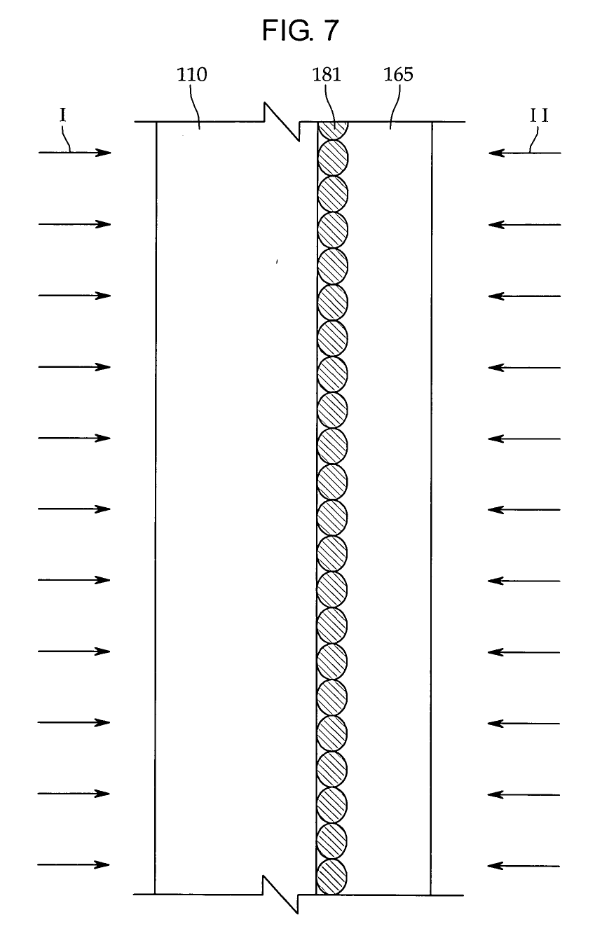

FIG. 7 shows the filter in which the hard coating layer 165 and the transparent substrate 110 are stacked in that order from the front.

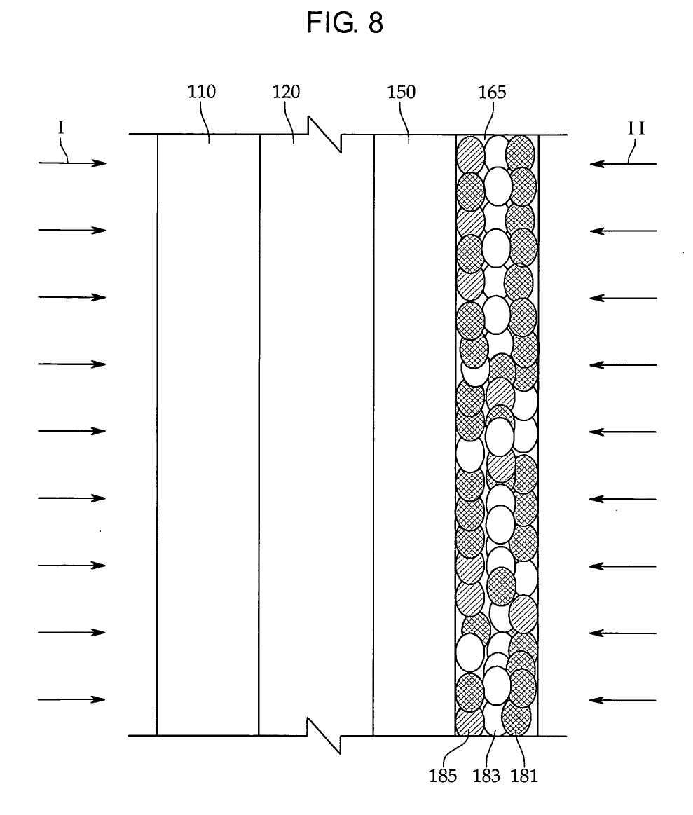

FIG. 8 shows the filter in which the hard coating layer 165, the color compensating layer 150, the electromagnetic shielding layer 120, and the transparent substrate 110 are stacked in that order from the front.

According to the present invention, various modification of the stacked order of the layers can be made. Further, the filter may include a hybrid layer, which performs functions of two or more layers.

For example, although the embodiment in which the color compensating layer 150 is located ahead of the external light shielding layer 130 is illustrated in FIG. 2, a modification in which the color compensating layer 150 may, be located behind the external light shielding layer 130. However, it is preferable that the color compensating layer 150 is preferably located near to the viewer. For example, the color compensating layer 150 may be located ahead of rather than behind the transparent substrate 110. Further, the external light shielding layer 130 may be interposed between the transparent substrate 110 and the electromagnetic shielding layer 120.

The transparent substrate 110 can be made of semi-tempered glass or transparent polymer resin. The polymer resin includes polyetylene terephthalate (PET), acryl, polycarbonate (PC), urethane acrylate, polyester, epoxy acrylate, brominate acrylate, polyvinyl chloride (PVC), or the like.

The electromagnetic shielding layer 120 can be typically classified into two types, a conductive mesh type and a conductive film type.

FIG. 1 shows the conductive mesh type electromagnetic shielding layer 121. The conductive mesh type electromagnetic shielding layer 121 has a structure in which a metal mesh pattern 121b is formed on a base 121a.

The conductive mesh type electromagnetic shielding layer 121 can generally use an earthed metal mesh or a structure in which a mesh of plastic or metal fabric is covered with metal.

Any metal can be selected for the mesh pattern 121b, as long as it has good electrical conductivity and is easy to fabricate. For example, copper, chrome, nickel, silver, tungsten, aluminum, or the like can be selected as the metal for the mesh pattern 121b.

The base 121a of the conductive mesh type electromagnetic shielding layer 121 can include a near-infrared absorption colorant based on diimmonium. In this case, the conductive mesh type electromagnetic shielding layer 121 has a green color or a brown color.

The conductive mesh type electromagnetic shielding layer 121 preferably has sheet resistance ranging from about 0.025 Ω/square to about 0.4 Ω/square.

If the sheet resistance exceeds 0.4 Ω/square, electromagnetic shielding performance degrades. Especially, recent display apparatuses are directed to a high quality of image, and thus are developed in the order of SD→HD→Full HD. In addition, the recent display apparatuses are required to have a complicated circuit structure due to various peripheral devices and many interfaces, thus cause a large quantity of electromagnetic waves. Therefore, the sheet resistance is required to be limited to 0.4 Ω/square or less.

If the sheet resistance is less than 0.2 Ω/square, the filter becomes too thick. Accordingly, when viewing a display apparatus from the side, visibility becomes poor and a color of cooper is seen. For these reasons, such sheet resistance has an adverse influence on a quality of image. Such a problem can be solved by blackening the side surface of the filter. However, the blackening process itself increases the production cost. In addition, the increase in thickness also causes the production cost to increase. This acts as a factor that deteriorates the competitiveness of products.

In FIG. 2, the conductive film type electromagnetic shielding layer 123 is shown. The conductive film type electromagnetic shielding layer 123 can be made in the form of a multilayered transparent thin film by alternately stacking a metal thin layer 123a of gold, silver, copper, platinum, palladium, or the like, and a high refractive transparent thin layer 123b of indium thin oxide (ITO), stannic oxide, zinc oxide (ZnO), aluminum doped zinc oxide (AZO), or the like. The conductive film type electromagnetic shielding layer 123 typically has a blue color or a green color.

The protective layer 140 can be formed on the electromagnetic shielding layer 120 or the external light shielding layer 130 in order to prevent oxidation and impurity sticking of the electromagnetic shielding layer 120 or the external light shielding layer 130.

The external light shielding layer 130 includes a base 132 made of transparent resin, and an external light shielding pattern 134 formed on one surface of the base 132. The external light shielding layer 130 may include a supporting layer.

The base 132 is a planar support made of transparent material that transmits visible light, and particularly can be made of PET, acryl, PC, urethane acrylate, polyester, epoxy acrylate, brominate acrylate, PVC, or the like.

The external light shielding pattern 134 is formed by filling an engraved pattern having a predetermined cross-sectional shape with light absorption material such as carbon black, and then hardening the filled light absorption material. The light absorption material serves to absorb external ambient light II.

Conductive material may be added in the external light shielding pattern 134. Silver paste can be selected as the conductive material. In the case in which the conductive material is added in the external light shielding pattern 134 and supplements an electromagnetic shielding function, the number of alternately stacking in the conductive film type electromagnetic shielding layer 123 can be reduced to one through three. The external light shielding pattern 134 may include a resin material in which polymer resin, binder, etc. are mixed with each other, in addition to the light absorption material and the conductive material.

The external light shielding pattern 134 typically has a stripe pattern when viewed from the front. The external light shielding pattern 134 may have various embodiments such as a corrugated pattern, a mesh pattern, and so on.

The external light shielding pattern 134 is made typically in the form of, but not limited to, wedge shaped stripes, namely a plurality of engraved three-dimensional triangular prism structures. For example, the external light shielding pattern 134 may have an embossed shape, or an engraved two-dimensional or multi-dimensional shape. In addition to the wedge cross-sectional shape, the external light shielding pattern 134 may have various cross-sectional shapes such as a rectangular cross-sectional shape, a trapezoidal cross-sectional shape, a U cross-sectional shape, and so on.

The external light shielding pattern 134 is formed in such a manner that a bottom face of its wedge shape parallel to one surface of the base 132 faces a display panel. However, the present invention is not limited to this configuration. In detail, the bottom face of the wedge shaped external light shielding pattern 134 parallel to one surface of the base 132 may face the viewer, and the external light shielding pattern 134 may be formed on both a front surface and a rear surface of the base 132.

The external light shielding layer 130 absorbs external light to prevent the external ambient light II from being incident onto the display panel, but totally reflects panel light I emitted from the display panel toward the viewer. Accordingly, high transmittance with respect to the visible light and high contrast ratio can be obtained at the same time.

If it is required to obtain a higher contrast ratio using only the external light shielding layer 130, the external light shielding pattern 134 has to increase a concentration of black color or change the wedge shape. However, in the case in which the wedge shape is changed, lengths of the wedges increase to deteriorate a vertical viewing angle.

In comparison with this configuration, for instance, the filter of FIG. 2 has more excellent external light absorption efficiency because the external light is dually absorbed by the color compensating layer 150, which will be described below, together with the external light shielding layer 130.

The anti-reflection layer 160 inhibits reflection of the external light to improve visibility.

The anti-reflection layer 160 can be made in the form of a single layer by forming a thin layer of fluorin-based polymer resin, magnesium fluoride, silicon-based resin or silicon oxide, which has a refractive index of 1.5 or less, and preferably 1.4 or less in a visible light region, for instance, at a quarter (¼) wavelength optical film thickness.

Further, the anti-reflection layer 160 can be made in the form of a multi-layer in which a thin film of an inorganic compound such as metal oxide, fluoride, silicide, boride, carbide, nitride, sulfide, etc. or a thin film of an organic compound such as silicon-based resin, acryl resin, fluorine-based resin, etc., which have different refractive ratios, is multi-stacked. For example, the anti-reflection layer 160 may have a structure in which a low refractive oxide film such as SiO₂ and a high refractive oxide film such as TiO₂ or Nb₂O₅ are alternately stacked.

In a conventional filter for a display apparatus, a blue reflection color is exhibited when a minimum reflection wavelength of the anti-reflection layer is shifted to a longer wavelength in the range of 550 nm to 620 nm, whereas a red reflection color is exhibited when the minimum reflection wavelength is shifted to a shorter wavelength. Particularly, the anti-reflection layer in which the minimum reflection wavelength is 550 nm exhibits a red color to degrade a quality of exterior.

Further, hollow silica used for a conventional anti-reflection layer is expensive, thus increasing the cost of production.

As illustrated in FIGS. 6, 7 and 8, the filter can be so designed that the low-refraction layer 161 or the hard coating layer 165 includes the black light absorption material 181, thereby preventing reflection of the external light, and furthermore exhibiting an achromatic color. Particularly, the filter can reduce expense of the material included in the color compensating layer which will be described below, and strongly realize a black color.

In the embodiment of FIG. 6, the high-refraction layer 163 and the low-refraction layer 161 are stacked once. Alternatively, these layers may be stacked plural times. Further, the high-refraction layer 163 and/or the hard coating layer 165 may be eliminated. Further, although the embodiment in which the black light absorption material 181 is included in the low-refraction layer 161 is shown, the black light absorption material 181 may be included in the hard coating layer 165 together with or instead of the low-refraction layer 161. The refractive index of the high-refraction layer 165 can be selected within a range of 1.8 to 2.5, and the refractive index of the low-refraction layer 161 can be selected within a range of 1.3 to 1.5.

The hard coating layer 165 must have high hardness and resistance to wear. The hard coating layer 165 can be made of acryl-based resin, urethane-based resin, or epoxy-based resin.

As the black light absorption material 181, carbon black can be representatively used. As the carbon black is used instead of the expensive hollow silica particles, the production cost can be reduced, and the light absorption function can also be obtained. Thus, the reflectance can be reduced compared to an existing anti-reflection layer.

Of course, as illustrated in FIG. 8, the low-refraction layer 161 and/or the hard coating layer 165 can include the hollow silica particles 183 and antistatic particles 185 in addition to the black light absorption material 181.

The filter can be so configured that the external light is absorbed doubly or triply by the low-refraction layer 161 and/or the hard coating layer 165 in which the black light absorption material 181 is included, the external light shielding layer, and the color compensating layer, thereby having very excellent external light absorption efficiency.

The filter for a plasma display panel (PDP) includes a diffusing layer (not shown) for preventing a Moire pattern and a Newton ring. The diffusing layer is preferably formed on a surface of the PDP filter adjacent to the display panel. However, as long as the diffusing layer can prevent the Moire pattern and the Newton ring, the diffusing layer can be formed at an arbitrary position within the PDP filter. In other words, the diffusing layer can be formed on a surface of the PDP filter which faces the viewer, i.e. in front of the anti-reflection layer.

A film having a surface undergoing an anti-glaring treatment can be used as the diffusing layer. Here, the anti-glaring treatment is a process that forms a fine uneven structure on the surface of the film using an appropriate method such as a rough surfacing treatment method based on sandblasting or embossing or a transparent particle blending method. Instead of the diffusing layer, a front substrate of the display panel can be subjected to the anti-glaring treatment.

The near-infrared shielding layer 170 blocks near-infrared rays. In the filter according to the embodiments of the present invention, the line spectrum of a near-infrared region, which is produced by the PDP device, is blocked by the near-infrared shielding layer 170. Thus, Even if a remote control device or an optical telecommunication appliance is used in the proximity of the PDP device, the PDP device does not interfere with the operation of the remote control device or the optical telecommunication appliance.

In FIG. 5, the near-infrared shielding layer 170 is formed as a separate layer. However, the near-infrared shielding layer 170 can be variously modified. For example, the near-infrared shielding layer 170 can also be formed as a hybrid layer which is obtained by adding near-infrared absorption material into the color compensating layer of FIG. 4.

The near-infrared shielding layer 170 includes near-infrared absorption material. For the near-infrared absorption material, a material that selectively absorbs light with specific wavelength of the near-infrared region is required.

The near-infrared absorption material is not specifically limited and can include, for example, a mixture of a diimmonium salt compound and at least one of a phthalocyanine compound and a nickel dithiol metal complex compound.

In the filter according to the embodiments of the present invention, the transmittance of the near infrared rays is preferably 10% or less. Particularly, the transmittance of the near infrared rays having a wavelength of 850 nm preferably meets this value. If the transmittance of the near infrared rays exceeds 10%, a possibility of causing the malfunction of a remote controller or a precise appliance due to the near-infrared rays is sharply increased.

The color compensating layer 150 so adjusts colors of the filter that CIE chromaticity coordinates of the filter have values of −2.0≦a*≦2.0 and −2.0≦b*≦2.0 under the standard of a D65 light source. These chromaticity coordinate values allow the filter according to the embodiments of the present invention to have an achromatic color. Thus, the color change of the panel light I caused by the filter can be minimized.

Meanwhile, sRGB chromaticity coordinates of the filter preferably have value of 0.85≦R/B≦1.15 and 0.85≦G/B ≦1.15. The filter having these chromaticity coordinate values exhibits the achromatic color overall by mixture of RGB.

The color compensating layer 150 so adjusts the colors that the CIE chromaticity coordinates of the filter have an L* value of 60≦L*≦80 under the standard of the D65 light source. This acts as an important feature of the embodiments of the present invention.

Table 1 shows the results of evaluating the filters by testing the filters in which the a* and b* values meet the conditions of −2.0≦a*≦2.0 and −2.0≦b*≦2.0, but the L* values are different from each other.

TABLE 1

| | L* < 60 | 60 ≦ L* ≦ 80 | 80 < L* |
|---|---|---|---|
| Quality of exterior | Good | Good | Bad |
| while power is OFF | | | |
| Luminance while | Bad | Good | Good |
| power is ON | | | |
| Bright room contrast | Good | Good | Bad |
| ratio while power | | | |
| is ON | | | |
| Elimination of | Good | Good | Bad |
| Moire phenomenon | | | |
| while power is ON | | | |

As can be seen from Table 1, when the filters have the value of 60≦L*≦80, the results of evaluating the filters are good.

When the L* value is less than 60, the luminance is low, and thus the viewer can feel dim while viewing the display apparatus. If discharge voltage is raised in order to make up for the low luminance, power consumption has to be increased, and withstand voltage parts must be used. This increases the cost of a product is increased, and shortens the life span of a phosphor.

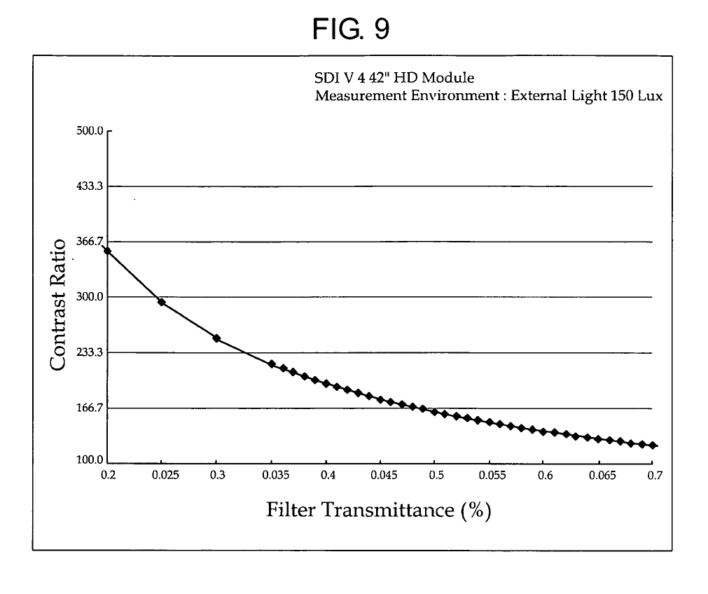

In contrast, when the L* value exceeds 80, the transmittance is very high, and thus the achromatic function is degraded. As a result, the color of a PDP panel is exposed to the front, and the exterior is not black while power is OFF. Accordingly, the quality of exterior becomes bad. Further, absorptance of the external ambient light is lowered, and the bright room contrast ratio (BRCR) is lowered. Furthermore, the Moire phenomenon relatively easily arises. FIG. 9 is a graph showing the relation between luminous average transmittance Y and contrast ratio with respect to an ordinary filter (measurement environment: external light of 150 Lux). It can be found from this graph that the higher the transmittance becomes, the lower the contrast ratio becomes.

Meanwhile, when the L* value exists between 60 and 80, the quality of exterior and the luminance efficiency are good, and the external light absorptance is high. Thus, a good bright room contrast ratio (BRCR) and a Moire elimination effect (especially, secondary Moire elimination effect) can be obtained.

The increase of the BRCR obtained by the external light absorption will be understood by means of the below equation.

BRCR=(luminance of white light+luminance of reflective light)/(luminance of black light+luminance of reflective light)

Thus, the embodiments of the present invention can increase the BRCR by reducing the reflective light luminance of both the denominator and the numerator. Since the white light luminance is very much higher than both the black light luminance and the reflective light luminance, the BRCR can be increased by lowering the BRCR.

The CIE chromaticity coordinates of the filter preferably have 0.305≦x≦0.315, 0.325≦y≦0.345 under the standard of the D65 light source. The filter having these chromaticity coordinate values has substantially the achromatic color. Thus, the color change to which otherwise, the panel light I will be subjected can be minimized.

Meanwhile, according the embodiments of the present invention, the luminous average transmittance Y of the filter preferably has 32%≦Y≦45% under the standard of the D65 light source.

The color compensating layer 150 optimizes spectral transmittance of the filter, and so adjusts the colors of the filter that the filter has the achromatic color to obtain optimal luminance.

Preferably, the transmittance of the light with a wavelength ranging from about 490 nm to about 700 nm has a value ranging from about 20% to about 50% under the standard of the D65 light source. More preferably, the transmittance of the light with a wavelength ranging from about 490 nm to about 700 nm has a value ranging from about 25% to about 45% under the standard of the D65 light source.

The light having a wavelength of 490 nm or less and the light having a wavelength of 700 nm or more are relatively insignificant. Therefore, the object of the present invention can be sufficiently accomplished by optimizing only the transmittance of the light having a wavelength ranging from about 490 nm to about 700 nm except the light beyond these limits.

This is because the reaction of a human eye is varied according to the wavelength. In other words, the human eye shows strongest reaction to the light having an intermediate wavelength and shows relatively weak reaction to the light having a shorter or longer wavelength, although they have the same energy.

The following Table 2 shows influences of the spectral transmittance of the light having the wavelength ranging from about 490 nm to about 700 nm.

TABLE 2

Range of transmittance

| | 0~30% | 20~50% | 40~70% |
|---|---|---|---|
| Quality of exterior when | Good | Good | Bad |
| power is OFF | | | |
| Luminance when power is ON | Bad | Good | Good |
| BRCR when power is ON | Good | Good | Bad |
| Elimination of | Good | Good | Bad |
| Moire phenomeon | | | |
| when power is ON | | | |

As can be seen from Table 2, when the spectral transmittance of the light having the wavelength ranging from about 490 nm to about 700 nm has a value within a range from 20% to 50%, the results are good.

In contrast, when the spectral transmittance has a range (e.g. from 0% to 30%) downwardly shifted out of the optimal range, the luminance becomes low, and thus the luminance characteristic of the display apparatus is degraded. As a result, the viewer can feel dim while viewing the display apparatus.

Reversely, when the spectral transmittance has a range (e.g. from 40% to 70%) upwardly shifted out of the optimal range, the transmittance is very high, and thus the achromatic function of the filter is degraded. As a result, the color of a PDP panel is exposed to the front, and an exterior does not have a black color while power is in OFF state. Accordingly, the quality of exterior becomes bad. Further, absorptance of the external ambient light is lowered, and the BRCR is lowered. Furthermore, the Moire phenomenon relatively easily arises.

Meanwhile, when the spectral transmittance has a wider range (e.g. from 0% to 70%) beyond the optimal range, the filter has a chromatic color. In this case, the color of the filter is added to that of the panel light I, which causes the color of the panel light to be changed.

The constituent parts used for the PDP filter, i.e. the near-infrared shielding layer, the color compensating layer, the conductive film type electromagnetic shielding layer, etc., have their own original colors, and thus the PDP filter including these constituent parts has a specific body color.

In the embodiments of the present invention, in consideration of the fact that cabinets of most PDP devices are based on a glossy black color, an opaque black color, or a silver color, the body color of the PDP filter is designed to have the achromatic color that satisfies the L*, a* and b* values of the CIE chromaticity coordinates.

With this configuration, even when power is in OFF state, the PDP device has a good quality of exterior.

Further, when power is in ON state, the filter prevents the color of the panel light from being changed, so that an actual color of the image is displayed to the viewer without a color change. Thereby, an enhanced quality of image can be provided to the viewer. In particular, when a black image for darkness is displayed, the black color is properly output, and thus a good quality of image can be provided to the viewer.

The color compensating layer can serve not only to improve color purity, but also prevent reflection.

Hereinafter, the blending of colorants for obtaining the aforementioned chromaticity coordinates will be described.

The electromagnetic shielding layer 120 has the color as described above. Further, a neon-cut colorant that is generally used in a conventional color compensating layer absorbs light ranging from about 560 nm to about 620 nm, so that a transmitted amount of light of a blue or green region is relatively more than that of light of a red region.

Thus, in the embodiments of the present invention, a colorant that absorbs the light of the blue or green region is appropriately added to the color compensating layer 150 in addition to the neon-cut colorant, so that the lights of the red, green and blue regions can uniformly transmit the filter to the outside.

The color compensating layer 150 includes two or more colorants and polymer resin.

The color compensating layer 150 includes a first colorant, which absorbs light ranging about 380 nm to about 480 nm, in the amount of 0.01 to 1 wt % in comparison with an amount of the polymer resin, a second colorant, which absorbs light ranging about 450 nm to about 550 nm, in the amount of 0.01 to 2 wt % in comparison with an amount of the polymer resin, and a third colorant, which absorbs light ranging about 560 nm to about 620 nm, in the amount of 0.01 to 1 wt % in comparison with an amount of the polymer resin.

If the blending proportion of each colorant deviates from the ranges, for instance is less than 0.01 wt %, an absorption amount of the light having the corresponding wavelength is lowered, and thus the transmittance of the light having the corresponding wavelength is increased. If the blending proportion of the colorants is more than 1 wt % (or 2 wt % for the second colorant), an absorption amount of the light having the corresponding wavelength becomes excessive, and thus the transmittance of the light having the corresponding wavelength is decreased. The more the amount of colorant is added, the lower the L* value becomes. In contrast, the less the amount of colorant is added, the higher the L* value becomes.

According to test results, the blending proportions preferably range from 0.01 to 1 wt % for the first and third colorants, and from 0.01 to 2 wt % for the second colorant, as described above.

Each colorant selectively absorbs the light in a specific wavelength range, and attains maximum absorption at an intrinsic wavelength. According to one embodiment, the first colorant may attains the maximum absorption at a wavelength of 438 nm, the second colorant attains the maximum absorption at a wavelength of 524 nm, and the third colorant attains the maximum absorption at a wavelength of 593 nm. The first colorant absorbs the light of the blue region, and the second colorant absorbs the light of the green region. The third colorant serves as neon-cut.

The colorants, which selectively absorb the light in a specific wavelength range, include dyes based on cyanine, anthraquinone, naphtoquinone, phthalocyanine, naphthalocyanine, diimmonium, nickel-dithiol, azo, stryl, methane, porphyrin, azaporphyrin, or the like.

According to the present invention, the filter can be so designed that minimum spectral transmittance of light having a wavelength ranging about 550 nm to about 600 nm ranges from 10% to 40%. If the minimum spectral transmittance of light having a wavelength ranging about 550 nm to about 600 nm is less than 10%, it is difficult to balance RGB, and the transmittance is overall shifted downwards, thus the luminance becoming low. In contrast, if the minimum spectral transmittance of light having a wavelength ranging about 550 nm to about 600 nm is more than 40%, the neon-cut function becomes bad. Further, the filter for a display apparatus can be so configured that average transmittance of light having a wavelength ranging about 450 nm to about 550 nm is less than 50%. If the average transmittance of light having a wavelength ranging about 450 nm to about 550 nm exceeds 50%, the color B or G becomes strong, and thus the filter is colored.

### EXAMPLES

A color compensating film was prepared by using a PET resin, a yellow colorant of Orasol series available from Ciba as a first colorant that absorbs a light having a wavelength ranging from 380 nm to 480 nm, a red colorant of Orasol series available from Ciba as a second colorant that absorbs a light having a wavelength ranging from 450 nm to 550 nm and an azaporphyrin-based colorant as a third colorant that absorbs a light having a wavelength ranging from 560 nm to 620 nm.

Then, filters of first and second examples were manufactured by joining the color compensating film, prepared as above, to one side of a semi-tempered glass substrate, and forming an electromagnetic shielding layer on the other side of the semi-tempered glass substrate. The contents of the colorants included in the color compensating layers and the types of the electromagnetic shielding layers according to the filters of the first and second examples are reported in Table 3 below.

In the meantime, a filter of a first comparative example was manufactured by using only a Neon cut colorant as the third colorant, and a filter of a second comparative example was manufactured by using only the second and third colorants. The contents of the colorants and the electromagnetic shielding layer used in the filters of the first and second comparative examples are also reported in Table 3 below.

TABLE 3

| | Electromagnetic | 1^{st} | 2^{nd} | 3^{rd} |
|---|---|---|---|---|
| | shielding layer | colorant | colorant | colorant |
| 1^{st} example | Conductive film | 0.7 wt % | 0.7 wt % | 0.12 wt % |
| | coating layer | | | |
| 2^{nd} example | Conductive mesh layer | 0.7 wt % | 0.8 wt % | 0.12 wt % |
| 1^{st} comp. | Conductive film layer | — | — | 0.12 wt % |
| example | | | | |
| 2^{nd} comp. | Conductive mesh layer | — | 0.7 wt % | 0.12 wt % |
| example | | | | |

The body colors of the PDP filters according to the first and second examples of the invention and the first and second comparative examples were measured using a D65 light source, CIE 1934 L*a*b* and spectrophotometer, and the results are reported in Table 4 below.

TABLE 4

| | L* | a* | b* |
|---|---|---|---|
| 1^{st} example | 70.86 | 0.079 | −0.83 |
| 2^{nd} example | 70.52 | −0.61 | 1.03 |
| 1^{st} comp. example | 80.06 | −4.72 | −12.29 |
| 2^{nd} comp. example | 72.23 | 1.5 | −6.00 |

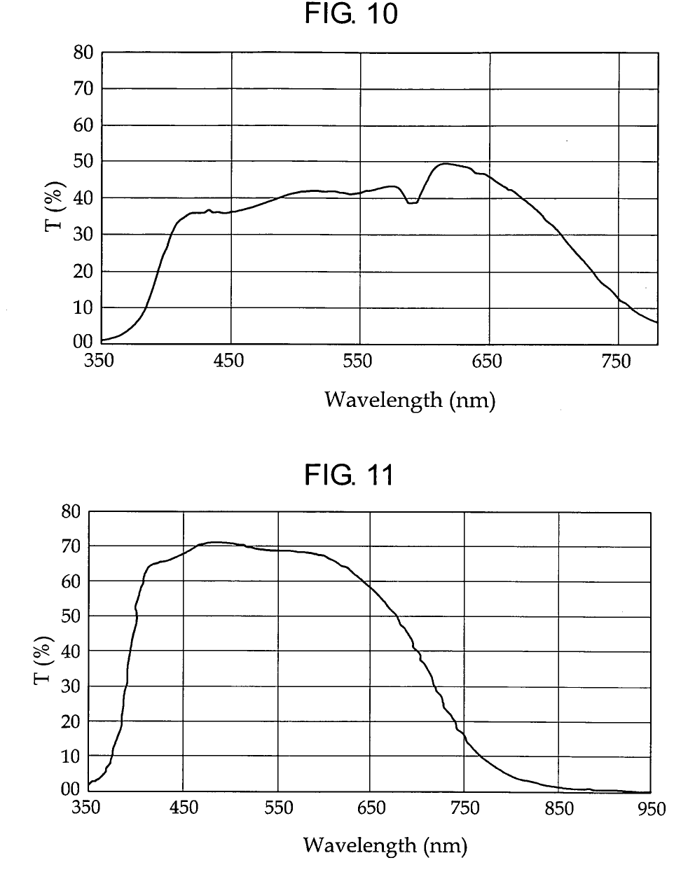

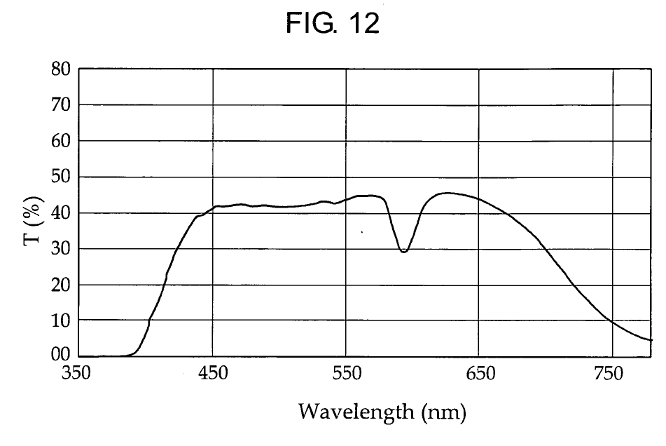

FIG. 10 is a graph showing a spectrum obtained by measuring the filter for a display apparatus according to the first example of the invention, and FIGS. 11 and 12 are graphs showing spectrums obtained by measuring the filters for a display apparatus according to the first and second comparative examples, which will be compared to the invention.

In FIGS. 10 to 12, a horizontal axis represents light wavelengths, and a vertical axis represents spectral transmittances.

From the transmittance spectrum of the filter according to the first example of the invention, it is apparent that the minimum spectral transmittance of a light having a wavelength ranging from about 550 nm to about 600 nm is in the range from 10% to 40% and that the filter according to the first example exhibits an achromatic color.

In the case of the second example, as seen from Table 3 above, the filter also exhibits an achromatic color since the values of a* and b* are in the vicinity of zero (0).

However, in the case of the first and second comparative examples, the PDP filters exhibit a blue or green color.

Comparing FIGS. 10 and FIG. 11, the PDP filter of FIG. 11 has stronger blue and green colors since lights having wavelengths ranging from about 380 nm to about 480 nm and from about 450 nm to about 550 nm are not absorbed but are allowed to pass through the filter.

The foregoing first to third colorants are contained typically in the color compensating layer. Of course, the first to third colorants can be contained in other layers of the filter. For example, the low-refraction layer and the hard coating layer can contain the foregoing light absorption material together with or in replacement of a colorant capable of selectively absorbing a light of a specific wavelength, e.g., at least one of the foregoing first to third colorants. Further, the external light shielding layer and the electromagnetic shielding layer can also contain the colorant capable of selectively absorbing a light of a specific wavelength, e.g., at least one of the foregoing first to third colorants.

Although not shown, respective layers of the filter can be adhered or bonded by an adhering or bonding layer. Here, this adhering or bonding layer can also contain the colorant capable of selectively absorbing the light of a specific wavelength, e.g., at least one of the foregoing first to third colorants.

While the present invention has been described with respect to the PDP filter and the PDP apparatus as an example for the convenience sake of description, this is not intended to limit the present invention. The filter for a display apparatus of the invention is applicable to a variety of display apparatuses which have pixels and generates RGB colors including a PDP apparatus, an organic light emitting diode (OLED) apparatus, a field emission display (FED) apparatus, and so on.

What is claimed is:

1. A filter for a display apparatus placed in front of a display panel, wherein CIE chromaticity coordinates of the filter under a standard of a D65 light source have values of −2.0≦a*≦2.0 and −2.0≦b*≦2.0.

2. The filter according to claim 1, wherein the CIE chromaticity coordinates of the filter under the standard of the D65 light source have a value of 60≦L*≦80.

3. The filter according to claim 1, wherein a luminous average transmittance (Y) of the filter under the standard of the D65 light source has a value of 32% ≦Y≦45%.

4. The filter according to claim 1, wherein sRGB chromaticity coordinates of the filter under the standard of the D65 light source have values of 0.85≦R/B ≦1.15 and 0.85≦G/B≦1.15.

5. The filter according to claim 1, wherein a minimum spectral transmittance of 550 nm to 600 nm wavelength light under the standard of the D65 light source ranges from 10% to 40%.

6. The filter according to claim 1, wherein a spectral transmittance of 490 nm to 700 nm wavelength light under the standard of the D65 light source ranges from 20% to 50%.

7. The filter according to claim 6, wherein a spectral transmittance of 490 nm to 700 nm wavelength light under the standard of the D65 light source ranges from 25% to 45%.

8. The filter according to claim 1, wherein the CIE chromaticity coordinates of the filter under the standard of the D65 light source have values of 0.305≦x≦0.315 and 0.325≦y≦0.345.

9. The filter according to claim 1, wherein a transmittance of near infrared rays with 850 nm wavelength is 10% or less.

10. The filter according to claim 1, comprising at least two sorts of colorants that selectively absorb different wavelength lights.

11. The filter according to claim 10, wherein the colorants comprise a first colorant absorbing 380 nm to 480 nm wavelength light, a second colorant absorbing 450 nm to 550 nm wavelength light, and a third colorant absorbing 560 nm to 620 nm wavelength light.

12. The filter according to claim 11, wherein the first to third colorants are contained in at least one of a color compensating layer, a low-refraction layer having a refractive index of 1.5 or less, an external light shielding layer, a hard coating layer and an adhesive layer.

13. The filter according to claim 1, comprising at least one of an electromagnetic shielding layer, a diffusing layer, an external light shielding layer having an external light shielding pattern in which a light absorption material is filled, a low-refraction layer having a refractive index of 1.5 or less in which a first black light absorption material is dispersed, and a hard coating layer in which a second black light absorption material is dispersed.

14. The filter according to any one of the preceding claims 1 to 13, wherein the display apparatus is a plasma display panel apparatus.
